(19) United States
(12) Patent Application Publication
(10) Pub. No.: US 2012/0160930 A1
(43) Pub. Date: Jun. 28, 2012

(54) AIR TREATMENT DEVICE AND METHOD

(76) Inventor: Ashok V. Joshi, Salt Lake City, UT (US)

(21) Appl. No.: 13/335,192

(22) Filed: Dec. 22, 2011

Related U.S. Application Data
(60) Provisional application No. 61/427,634, filed on Dec. 28, 2010.

(51) Int. Cl. B05B 1/24

(52) U.S. Cl. 239/136

(57) ABSTRACT

An air treatment device includes a container containing a mixture. The container allows the mixture to be selectively exposed to ambient air. In one embodiment, the mixture contains at least the following: (1) a heat-generating material that generates heat when exposed to ambient air; and (2) a volatile substance in intimate contact with the heat-generating material and inert relative to the heat-generating material, wherein the volatile substance vaporizes in the presence of heat. In another embodiment, the mixture contains at least the following: (1) a gas-generating material that produces gas when exposed to ambient air; and (2) a volatile substance in intimate contact with the gas-generating material and inert relative to the gas-generating material, wherein the volatile substance vaporizes in the presence of the generated gas. Corresponding methods are also disclosed herein.

### RELATED APPLICATIONS

This application claims priority to U.S. Provisional Patent No. 61/427,634 filed on Dec. 28, 2010 and entitled AIR TREATMENT DEVICE AND METHOD.

### BACKGROUND OF THE INVENTION

1. Field of the Invention

This invention relates to apparatus and methods for releasing substances into the atmosphere.

2. Background

Different types of devices have been designed to release substances into the atmosphere or other environments over a period of time. Examples of such devices include various types of air fresheners designed to release fragrances or deodorizing agents into the atmosphere. Other analogous devices include those that emanate or release insect repellants, pesticides, disinfectants, antimicrobial agents, medicines, and other beneficial agents.

Within the field of air fresheners, a wide variety of different devices exist. For example, scented candles and devices using flames or other heat sources may be used to heat and vaporize a fragrance for release into the atmosphere. Incense burners may be used to burn aromatic biotic materials to release fragrant smoke. Wall plug-ins may utilize piezoelectricity to aerosolize a fragrance or use heat to vaporize it. Fragrance-impregnated gels are widely used to release fragrances into the atmosphere as the gels evaporate. Wick and reed diffusers soaked with fragrances may be used to disperse the fragrances by evaporation. Fragrance-impregnated materials such as floor wax, paper, plastics, and wood may release fragrances into the atmosphere by offgassing. Nebulization systems may convert liquid fragrances into vapors without the use of heat.

Many of the air freshener devices discussed above, however, suffer from various shortcomings. For example, some devices may be mechanically complex and thus may be too unreliable or expensive to produce for mass consumption. Other devices may have safety issues. For example, scented candles or incense burners may create fire hazards and thus may not be suitable for long periods of unattended use. Other devices may release their fragrances too quickly, thereby making them unsuitable for long term use. Yet other devices may suffer from inconsistent release rates. For example, the release rates of fragrance-impregnated gels or materials may diminish over time, making them less effective as time passes.

In view of the foregoing, what are needed are apparatus and methods that address may of the shortcomings of the prior art. In particular, apparatus and methods are needed to controllably release substances into the atmosphere in a simple, reliable, and inexpensive manner. Further needed are apparatus and methods to controllably release substances into the atmosphere over significant periods of time and with consistent release rates.

### SUMMARY

The invention has been developed in response to the present state of the art and, in particular, in response to the problems and needs in the art that have not yet been fully solved by currently available apparatus and methods. Accordingly, the invention has been developed to provide novel apparatus and methods for releasing substances into the atmosphere. The features and advantages of the invention will become more fully apparent from the following description and appended claims, or may be learned by practice of the invention as set forth hereinafter.

Consistent with the foregoing, an air treatment device is disclosed herein. In one embodiment, such an air treatment device includes a container containing a mixture. The container allows the mixture to be selectively exposed to ambient air. The mixture contains at least the following: (1) a heat-generating material that generates heat when exposed to ambient air; and (2) a volatile substance in intimate contact with the heat-generating material and inert relative to the heat-generating material, wherein the volatile substance vaporizes in the presence of heat. A corresponding method is also disclosed and claimed herein.

In another aspect of the invention, an air treatment device in accordance with the invention includes a container containing a mixture. The container allows the mixture to be selectively exposed to ambient air. The mixture contains at least the following: (1) a gas-generating material that produces gas when exposed to ambient air; and (2) a volatile substance in intimate contact with the gas-generating material and inert relative to the gas-generating material, wherein the volatile substance vaporizes in the presence of the generated gas. A corresponding method is also disclosed and claimed herein.

### BRIEF DESCRIPTION OF THE DRAWINGS

In order that the advantages of the invention will be readily understood, a more particular description of the invention briefly described above will be rendered by reference to specific embodiments illustrated in the appended drawings. Understanding that these drawings depict only typical embodiments of the invention and are not therefore to be considered limiting of its scope, the invention will be described and explained with additional specificity and detail through use of the accompanying drawings in which:

FIG. 1 is a cross-sectional view of one embodiment of an air treatment device in accordance with the invention;

FIGS. 2A and 2B illustrate a first method for controllably releasing a volatile substance;

FIG. 3 illustrates a second method for controllably releasing a volatile substance;

FIG. 4 illustrates an alternative structure for circulating ambient air through an air treatment device in accordance with the invention;

FIGS. 5A and 5B illustrate a structure for regulating a flow of ambient air into, as well as a flow of vaporized volatile substance out of, an air treatment device in accordance with the invention;

FIG. 6 shows an alternative structure for regulating a flow of ambient air into, as well as a flow of vaporized volatile substance out of, an air treatment device in accordance with the invention; and

FIG. 7 shows one embodiment of an air treatment device that includes a water reservoir.

### DETAILED DESCRIPTION OF THE INVENTION

It will be readily understood that the components of the present invention, as generally described and illustrated in the Figures herein, could be arranged and designed in a wide variety of different configurations. Thus, the following more detailed description of the embodiments of the invention, as represented in the Figures, is not intended to limit the scope of the invention, as claimed, but is merely representative of certain examples of presently contemplated embodiments in accordance with the invention. The presently described embodiments will be best understood by reference to the drawings, wherein like parts are designated by like numerals throughout.

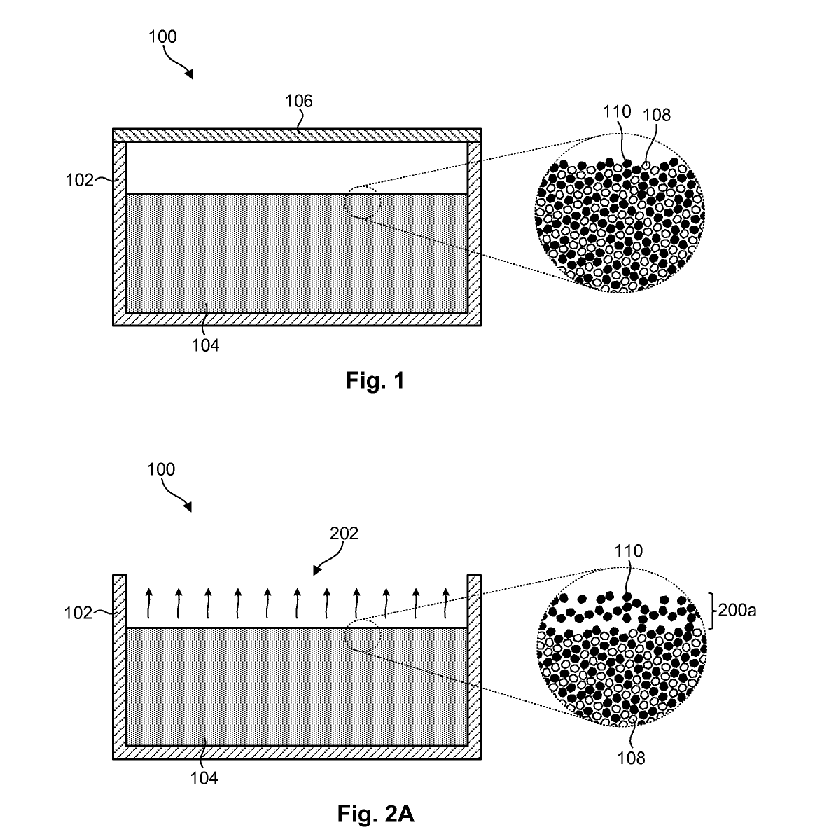

Referring to FIG. 1, a cross-sectional view of one embodiment of an air treatment device 100 in accordance with the invention is illustrated. As shown the air treatment device 100 includes a container 102 containing a mixture 104. This mixture 104 contains a volatile substance 108 that is vaporized and released from the mixture 104 when the mixture 104 is exposed to ambient air. The volatile substance 108 may include any material that is capable of being vaporized and provides a desired benefit when released into ambient air. Such substances 108 may include, for example, fragrances, insecticides, insect repellants, sanitizers, deodorants, medicines, or the like.

To vaporize and release the volatile substance 108, the volatile substance 108 is mixed with a vaporizing material 110 which is inert relative to the volatile substance 108. This vaporizing material 110 vaporizes the volatile substance 108 when the vaporizing material 110 is exposed to ambient air. In one embodiment, the vaporizing material 110 is a heat-generating material 110 that produces heat when exposed to ambient air. In another embodiment, the vaporizing material 110 is a gas-generating material 110 that produces gas when exposed to ambient air. In either case, the vaporizing material 110 vaporizes and releases the volatile substance 108 when the vaporizing material 110 is exposed to ambient air. In certain embodiments, any reaction products produced by the vaporizing material 110 upon reacting with ambient air are inert relative to the volatile substance 108.

In certain embodiments, both the vaporizing material 110 and volatile substance 108 are powders that are mixed together to form the mixture 104, thereby ensuring that the vaporizing material 110 and volatile substance 108 are in intimate contact with one another. In certain embodiments, a gelling agent or other materials are added to the mixture 104 to impart desired characteristics to the mixture 104. For example, a gelling agent may create a mixture 104 that has the properties of a gel. Such a gelling agent may also be volatile in nature and vaporize along with the volatile substance 108. Nevertheless, in other embodiments, the mixture 104 is provided in other forms, such as composites, slurries, pastes, dry powder mixtures, or the like.

As mentioned above, in certain embodiments the vaporizing material 110 is a heat-generating material 110 that produces heat when exposed to ambient air. In such embodiments, the volatile substance 108 is a substance that vaporizes in the presence of heat or increases its rate of vaporization in the presence of heat. Various different materials may be used as heat-generating materials 110. For example, various types of metal powders, such as powders of Fe, Zn, Ca, Mg, or mixtures thereof, may be used as heat-generating materials 110. Such metal powders oxidize when exposed to oxygen, releasing energy in the form of heat in the process. The heat may, in turn, be used to vaporize the volatile substance 108 or increase the rate of vaporization of the volatile substance 108.

In certain embodiments, different chemicals may be added to the mixture 104 to alter the manner in which the volatile substance 108 is released from the mixture 104. For example, in certain embodiments, salt may be added to the mixture 104 to act as a catalyst. This may speed up the chemical reaction between the metal powder and oxygen, thereby producing heat in a more rapid manner. In other embodiments, carbon may be added to the mixture 104 to act as a dispersant agent, thereby allowing heat to be more evenly distributed through the mixture 104. In other embodiments, vermiculite may be added to the mixture 104 to retain heat within the mixture 104. These represent just a few examples of materials that may be added to the mixture 104 to alter the manner in which the volatile substance 108 is released. In some cases, a quicker release of the volatile substance 108 may be desired and chemicals may be added to or omitted from the mixture 104 to quicken the release. In other cases, a slower more sustained release of the volatile substance 108 may be desired and chemicals may be added to or omitted from the mixture 104 to slow the release.

As mentioned above, in certain embodiments the vaporizing material 110 is a gas-generating material 110 that produces gas when exposed to ambient air. In such embodiments, the volatile substance 108 is a substance that vaporizes in the presence of the gas, or increases its rate of vaporization in the presence of gas. Various different materials or mixtures of materials may be used as a gas-generating material 110. For example, in certain embodiments, the gas-generating material 110 includes one or more of metal carbonate, metal bicarbonate, organic acid, metal hydride, and metal powder.

If the gas-generating material 110 is a metal carbonate or metal bicarbonate, the metal may include an alkali metal (e.g., Na, K, Li, etc.) or an alkaline earth metal (e.g., Ca, Mg, Ba, etc.). If the gas-generating material 110 is a metal hydride, the metal hydride may include an alkali metal hydride (e.g., sodium hydride, potassium hydride, lithium hydride, etc.) or an alkaline-earth metal hydride (e.g., calcium hydride, magnesium hydride, barium hydride, etc.). If the gas-generating material 110 is a metal powder, the metal powder may include, for example, powders of Fe, Zn, Ca, and Mg. Similarly, if the gas-generating material 110 includes an organic acid, the organic acid may include one or more of citric acid, oxalic acid, and uric acid. In certain embodiments, the organic acid in the gas-generating material 110 is provided in solid form. For example, anhydrous citric acid comes in the form of a white crystalline powder.

In one particular embodiment, the gas-generating material 110 includes a mixture of sodium bicarbonate and citric acid. When the sodium bicarbonate and citric acid comes into contact with moisture in ambient air, the mixture reacts with the moisture to generate one or more gases (e.g., carbon dioxide). Such gases will enhance the volatility of the volatile substance 108 to vaporize and release the volatile substance 108 into the surrounding environment, or increase the rate at which the volatile substance 108 is vaporized and released into the surrounding environment.

In another particular embodiment, the gas-generating material 110 includes calcium hydride. When the calcium hydride comes into contact with ambient air, the calcium hydride reacts with moisture in the ambient air to generate one or more gases (e.g., hydrogen). Such gases will enhance the volatility of the volatile substance 108 to vaporize and release the volatile substance 108 into the surrounding environment, or increase the rate at which the volatile substance 108 is vaporized and released into the surrounding environment.

In one embodiment, the mixture 104 is produced by mixing the volatile substance 108 and vaporizing material 110 in a dry atmosphere. In certain embodiments, a dry atmosphere is an atmosphere of less than fifteen percent humidity. In other embodiments, a dry atmosphere is an atmosphere of less than ten percent humidity. In certain embodiments, mixing the volatile substance 108 and vaporizing material 110 in a dry atmosphere includes mixing the constituents in a dry box. Nevertheless, the constituents may be mixed in any environment that prevents the vaporizing material 110 from substantially reacting with components in ambient air. Depending on the vaporizing material 110 and volatile substance 108 used, and the respective amounts thereof, the resulting mixture 104 may be a solid, semi-solid, suspended solid, or slurry. The resulting mixture 104 may then be placed in the container 102 and sealed to prevent exposure to ambient air. The seal 106 may be removed as needed to vaporize and release the volatile substance 108 into the ambient air.

As shown in FIG. 1, the container 102 is covered by a seal 106. Such a seal 106 may take on many different forms. In certain embodiments, the seal 106 is a flexible covering that may be removed, pealed back, or punctured to expose the mixture 104 to ambient air. This flexible covering may or may not be reattached to reseal the container 102. In other embodiments, the seal 106 is a cap or cover that may be unscrewed, popped off, popped open, or the like, to expose the mixture 104. The cap or cover may or may not be used to reseal the container 102. If the container 102 is a bag or pouch, breaking the seal 106 may be as simple as cutting off a corner or tearing the bag or pouch to expose the mixture 104 contained therein.

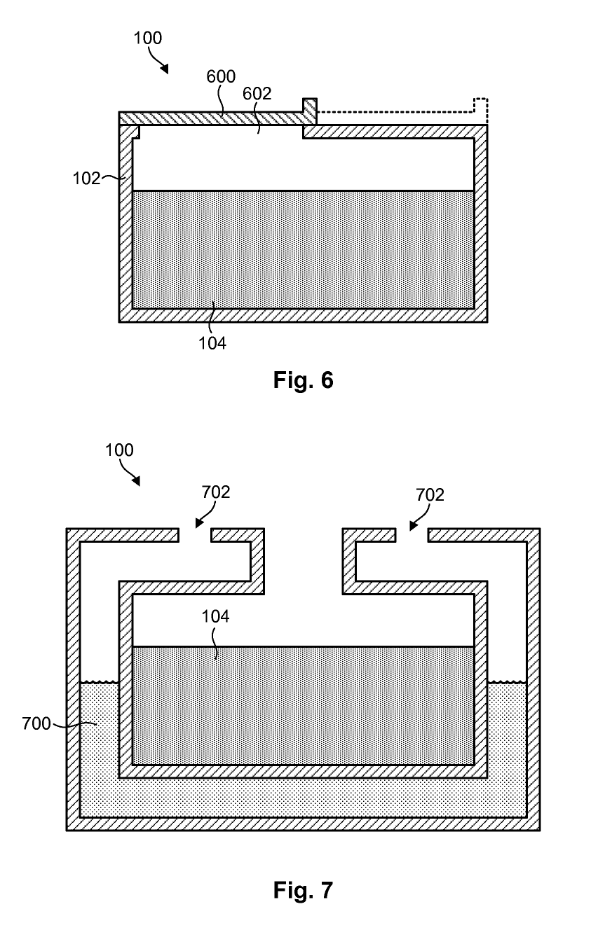

In certain embodiments, the seal 106 may be removed all or in part to adjust the exposure of the mixture 104 to ambient air. For example, partially opening the container may slow the reaction between ambient air and the vaporizing material 110 to vary the rate at which the volatile substance 108 is released from the air treatment device 100. Likewise, fully opening the container 102 may maximize the reaction between ambient air and the vaporizing material 110. One example of an air treatment device 100 with an adjustable opening will be described in association with FIGS. 5A and 5B.

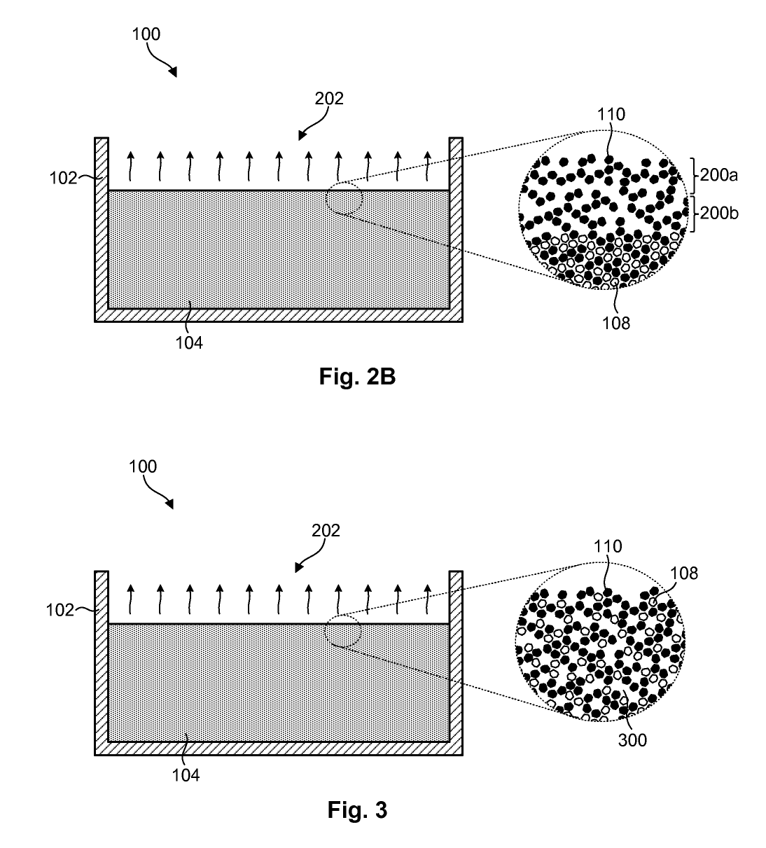

Referring to FIGS. 2A and 2B, in selected embodiments, the air treatment device 100 is designed to controllably release a volatile substance 108 over a period of time. This may be accomplished, for example, by releasing the volatile substance 108 one layer at a time. Initially, only a top layer of the volatile substance 108 and vaporizing material 110 may be exposed to ambient air. The top layer of vaporizing material 110 may vaporize and release the volatile substance 108 in the top layer, thereby creating porosity in the mixture 104 which exposes the next layer of volatile substance 108 and vaporizing material 110 to ambient air. The next layer of vaporizing material 110 may then vaporize and release the volatile substance 108 in the layer. This will expose the next layer of volatile substance 108 and vaporizing material 110. This process will continue until all of the volatile substance 108 is vaporized and released. In this way, the volatile substance 108 is gradually released over time, layer by layer.

FIG. 2A shows the mixture 104 after several initial layers 200a of the volatile substance 108 have been vaporized and released. FIG. 2B shows the mixture 104 after additional layers 200b of the volatile substance 108 have been vaporized and released. Although these Figures show the top layers of the volatile substance 108 to be initially vaporized and released, other layers including side and bottom layers of the volatile substance 108 may be initially vaporized and released depending on the placement of the opening 202 relative to the mixture 104.

It should be recognized that the vaporizing material 110 may be chemically altered as it vaporizes and releases the volatile substance 108. For example, if the vaporizing material 110 is a metal powder (a heat-generating material 110), the metal powder may react with oxygen to form metal oxide, while also generating heat. On the other hand, if the vaporizing material 110 is calcium hydride (a gas-generating material 110), the calcium hydride may react with moisture in the ambient air to form calcium hydroxide, while releasing hydrogen gas. If the vaporizing material 110 is a mixture of sodium bicarbonate and citric acid (a mixture that acts as a gas-generating material 110), the sodium bicarbonate and citric acid may react with moisture in the ambient air to form sodium citrate, while releasing carbon dioxide gas.

Referring to FIG. 3, in other embodiments, the mixture 104 may be designed to release the volatile substance 108 substantially evenly throughout. For example, the mixture 104 may be designed with porosity 300 to allow ambient air to infiltrate the mixture 104 substantially evenly. This will create substantially even gas and/or heat generation through the mixture 104. This will likewise cause the volatile substance 108 to be vaporized and released throughout the mixture 104. The vaporized volatile substance 10 may flow through the porosity 300 for release into the surrounding atmosphere.

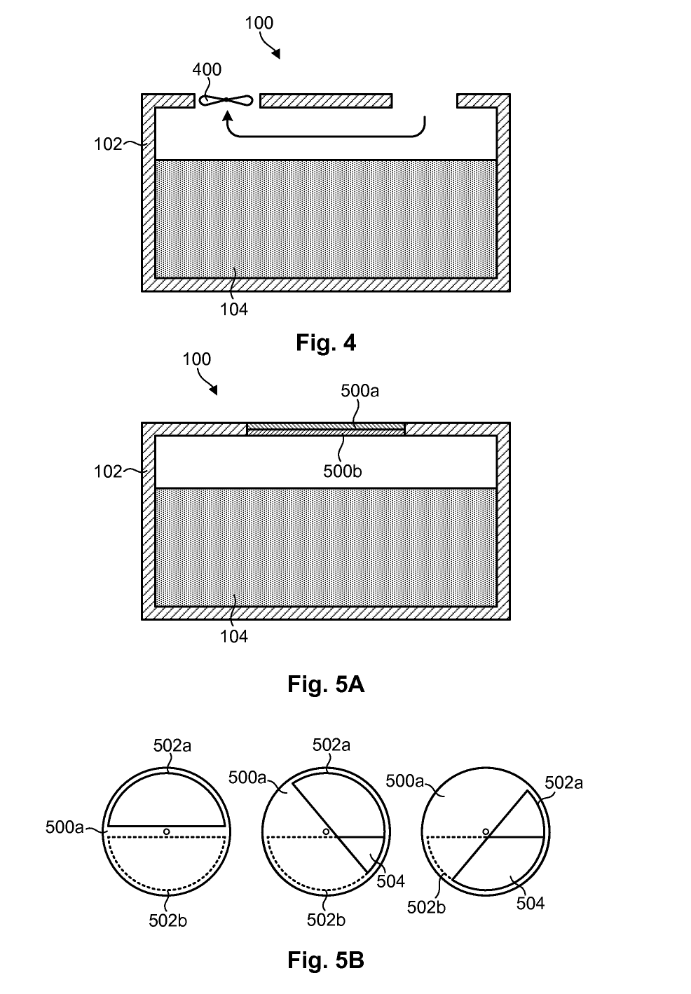

Referring to FIG. 4, in selected embodiments, the air treatment device 100 may include various mechanisms to enhance the flow of ambient air through the air treatment device 100. For example, in one embodiment, a fan 400 may circulate air through the air treatment device 100 to control the reaction between the air and the vaporizing material 110. If desired, the fan 400 may be turned off or slowed to slow the reaction between ambient air and the vaporizing material 110, thereby slowing the release of the volatile substance 108. The speed of the fan 400 may be increased to speed up the reaction between ambient air and the vaporizing material 110, thereby speeding up the release of the volatile substance 108. In certain embodiments, the fan 400 may also help to disseminate the vaporized volatile substance 108 throughout the ambient air. In other embodiments, in place of or in addition to a fan 400, a heating element may be used to circulate air through the air treatment device 100 to control the reaction between the ambient air and the vaporizing material 110, as well as disseminate the volatile substance 108 into the ambient air.

Referring to FIGS. 5A and 5B, as previously mentioned, in selected embodiments, the air treatment device 100 includes an adjustable opening. The adjustable opening may regulate the reaction between the ambient air and the vaporizing material 110 by controlling the flow of ambient air into the air treatment device 100. Partially opening the adjustable opening may slow the reaction between the ambient air and the vaporizing material 110 to slow that rate at which the volatile substance 108 is released from the air treatment device 100. Fully opening the adjustable opening may maximize the reaction between the ambient air and the vaporizing material 110 to maximize the rate at which the volatile substance 108 is released from the air treatment device 100.

As shown, the air treatment device 100 includes a pair of disks 500a, 500b, each having one or more apertures 502a, 502b, to create an adjustable opening 504. In one embodiment, the lower disk 500b is stationary and the upper disk 500a rotates relative to the lower disk 500b. As shown in FIG. 5B, each of the disks 500a, 500b may include an aperture 502a, 502b in the shape of a semi-circle. As the semi-circles are rotated relative to one another on their respective disks 500a, 500b, the opening 504 becomes larger or smaller, depending on the direction of rotation. Other aperture shapes are possible to achieve a same or similar result. Other types of adjustable openings are also possible. FIG. 6 shows one example of an adjustable opening that is implemented with a cover 600 that slides relative to an opening 602.

Referring to FIG. 7, in certain embodiments in accordance with the invention, the air treatment device 100 is incorporated into or includes other structures to enhance the operation of the air treatment device 100. FIG. 7 shows one example of an air treatment device 100 that includes a reservoir 700 for holding an amount of water or other aqueous solution. The water reservoir 700 may include openings 702 to allow water in its various forms, including water vapor or stream, to exit into the ambient air surrounding the air treatment device 100. This allows the air treatment device 100 to affect the amount of moisture in the ambient air, thereby controlling the rate of reaction with the vaporizing material 110 once the mixture 104 has been exposed to the ambient air. It will be appreciated that various control mechanisms known in the art may be employed to control the escape of water from the reservoir 700.

The present invention may be embodied in other specific forms without departing from its basic principles or essential characteristics. The described embodiments are to be considered in all respects as illustrative and not restrictive. The scope of the invention is, therefore, indicated by the appended claims rather than by the foregoing description. All changes which come within the meaning and range of equivalency of the claims are to be embraced within their scope.

1. An air treatment device comprising:
a mixture comprising (1) a heat-generating material that generates heat when exposed to ambient air; and (2) a volatile substance in intimate contact with the heat-generating material and inert relative to the heat-generating material, the volatile substance vaporizing in the presence of heat; and
a container containing the mixture and allowing the mixture to be selectively exposed to ambient air.

2. The air treatment device of claim 1, wherein each of the heat-generating material and volatile substance are provided in the form of powders.

3. The air treatment device of claim 1, wherein the mixture further comprises a gelling agent to transform the mixture into a gel.

4. The air treatment device of claim 3, wherein the gelling agent vaporizes in the presence of heat.

5. The air treatment device of claim 1, wherein the container comprises an opening and a seal to cover the opening.

6. The air treatment device of claim 5, wherein breaking the seal exposes the mixture to the ambient air.

7. The air treatment device of claim 1, wherein the volatile substance comprises at least one of a fragrance, an insecticide, an insect repellant, a sanitizer, a deodorant, and a medicine.

8. The air treatment device of claim 1, wherein the heat-generating material comprises a metal powder.

9. The air treatment device of claim 8, wherein the metal powder comprises at least one of an Fe, Zn, Ca, and Mg powder.

10. The air treatment device of claim 1, wherein the air treatment device is configured to controllably release the volatile substance by controllably exposing the heat-generating material to the ambient air.

11. A method for treating air, the method comprising:
providing a mixture comprising (1) a heat-generating material that generates heat when exposed to ambient air; and (2) a volatile substance in intimate contact with the heat-generating material and inert relative to the heat-generating material, the volatile substance vaporizing in the presence of heat; and
selectively exposing the mixture to ambient air to produce heat and thereby vaporize the volatile substance.

12. The method of claim 11, each of the heat-generating material and volatile substance are provided in the form of powders.

13. The method of claim 11, wherein the mixture further comprises a gelling agent to transform the mixture into a gel.

14. The method of claim 13, wherein the gelling agent vaporizes in the presence of heat.

15. The method of claim 11, wherein providing the mixture comprises providing the mixture in a container having an opening and a seal to cover the opening.

16. The method of claim 15, wherein selectively exposing the mixture comprises breaking the seal to expose the mixture to ambient air.

17. The method of claim 11, wherein the volatile substance comprises at least one of a fragrance, an insecticide, an insect repellant, a sanitizer, a deodorant, and a medicine.

18. The method of claim 11, wherein the heat-generating material comprises a metal powder.

19. The method of claim 18, wherein the metal powder comprises at least one of an Fe, Zn, Ca, and Mg powder.

20. The method of claim 11, further comprising controllably vaporizing the volatile substance by controllably exposing the heat-generating material to ambient air.

21. An air treatment device comprising:
a mixture comprising (1) a gas-generating material that produces gas when exposed to ambient air; and (2) a volatile substance in intimate contact with the gas-generating material and inert relative to the gas-generating material, the volatile substance vaporizing upon generation of the gas; and
a container containing the mixture and allowing the mixture to be selectively exposed to ambient air.

22. The air treatment device of claim 21, wherein each of the gas-generating material and volatile substance are provided in the form of a powder.

23. The air treatment device of claim 21, wherein the container comprises an opening and a seal to cover the opening.

24. The air treatment device of claim 23, wherein breaking the seal exposes the mixture to the ambient air.

25. The air treatment device of claim 21, wherein the gas-generating material comprises at least one of a metal carbonate, a metal bicarbonate, an organic acid, a metal hydride, and a metal powder.

26. The air treatment device of claim 21, wherein the volatile substance comprises at least one of a fragrance, an insecticide, an insect repellant, a sanitizer, a deodorant, and a medicine.

27. The air treatment device of claim 21, wherein the gas produced by the gas-generating material is inert relative to the volatile substance.

28. The air treatment device of claim 21, wherein the container comprises an adjustable opening to regulate the rate that ambient air enters the container.

29. The air treatment device of claim 28, wherein the adjustable opening further regulates the rate that gas exits the container.

30. The air treatment device of claim 21, wherein the air treatment device is configured to controllably release the volatile substance by controllably exposing the gas-generating material to the ambient air.

31. A method for treating air, the method comprising:
providing a mixture comprising (1) a gas-generating material that produces gas when exposed to ambient air; and (2) a volatile substance in intimate contact with the gas-generating material and inert relative to the gas-generating material, the volatile substance vaporizing upon generation of the gas; and
selectively exposing the mixture to ambient air to produce gas and thereby vaporize the volatile substance.

32. The method of claim 31, wherein each of the gas-generating material and volatile substance are provided in the form of a powder.

33. The method of claim 31, wherein providing the mixture comprises providing the mixture in a container comprising an opening and a seal to cover the opening.

34. The method of claim 33, wherein selectively exposing the mixture to ambient air comprises breaking the seal.

35. The method of claim 31, wherein the gas-generating material comprises at least one of a metal carbonate, a metal bicarbonate, an organic acid, a metal hydride, and a metal powder.

36. The method of claim 31, wherein the volatile substance comprises at least one of a fragrance, an insecticide, an insect repellant, a sanitizer, a deodorant, and a medicine.

37. The method of claim 31, wherein the gas produced by the gas-generating material is inert relative to the volatile substance.

38. The method of claim 33, further comprising adjusting an adjustable opening on the container to regulate the rate that ambient air enters the container.

39. The method of claim 38, further comprising adjusting the adjustable opening to regulate the rate that gas exits the container.

40. The method of claim 31, further comprising controllably vaporizing the volatile substance by controllably exposing the gas-generating material to ambient air.
